(19) United States
(12) Patent Application Publication
(10) Pub. No.: US 2026/0321149 A1
(43) Pub. Date: Oct. 15, 2026

(54) SYSTEMS, APPARATUSES, METHODS, AND COMPUTER PROGRAM PRODUCTS FOR PREDICTING CLEAR AIR TURBULENCE ALONG A FLIGHT PATH

(71) Applicant: Honeywell International Inc., Charlotte, NC (US)

(72) Inventors: Sreenivasan Govindillam, Bangalore (IN); SunilRaj Suseelan, Bangalore (IN)

(21) Appl. No.: 19/645,551

(22) Filed: Apr. 13, 2026

(30) Foreign Application Priority Data
Apr. 15, 2025 (IN) 202511036344

(51) Int. Cl. G08G 5/76

(52) U.S. Cl. CPC G08G 5/76

(57) ABSTRACT

Embodiments of the present disclosure provide clear air turbulence prediction techniques. Altitude dataset for each of one or more reference aircrafts within a spatial region encompassing a prospective segment of a flight path for a monitored aircraft may be received. The altitude dataset for each reference aircraft may comprise measured data for one or more altitude parameters. Abnormal altitude variation prediction may be generated for at least one reference aircraft of the one or more reference aircrafts by analyzing the altitude dataset for the at least one reference aircraft. A predicted clear air turbulence (CAT) output may be generated based on the abnormal altitude variation prediction for the at least one reference aircraft. The predicted CAT output may indicate a likelihood of CAT in the prospective segment of the flight path. Performance of one or more mitigation actions may be initiated based on the predicted CAT output.

### CROSS REFERENCE TO RELATED APPLICATIONS

This application claims priority to India Application No. 202511036344, filed on Apr. 15, 2025, the contents of which are hereby incorporated herein by reference in their entirety.

### TECHNOLOGICAL FIELD

Embodiments of the present disclosure generally relate to predicting clear air turbulence; and, particularly to systems, apparatuses, methods, and computer program products for predicting clear air turbulence along a flight path.

### BACKGROUND

Various embodiments of the present disclosure address technical challenges related to predicting clear air turbulence. Through applied effort, ingenuity, and innovation many deficiencies of existing techniques and systems have been solved by developing solutions that are in accordance with the embodiments as discussed herein, many examples of which are described in detail herein.

### BRIEF SUMMARY

In accordance with one aspect of the present disclosure, a computer-implemented method for predicting clear turbulence is provided. In some embodiments, the computer-implemented method comprises capturing, by one or more processors, altitude dataset for each of one or more reference aircrafts within a spatial region encompassing a prospective segment of a flight path for a monitored aircraft, wherein the altitude dataset for each reference aircraft comprises measured data for one or more altitude parameters; generating, by the one or more processors, abnormal altitude variation prediction for at least one reference aircraft of the one or more reference aircrafts by analyzing the altitude dataset for the at least one reference aircraft; generating, by the one or more processors, a predicted clear air turbulence (CAT) output based on the abnormal altitude variation prediction for the at least one reference aircraft, wherein the predicted CAT output indicates a likelihood of CAT in the prospective segment of the flight path; and initiating, by the one or more processors, performance of one or more mitigation actions based on the predicted CAT output.

In some embodiments, generating the predicted CAT output based on the abnormal altitude variation prediction comprises validating the abnormal altitude variation prediction; determining location data of the at least one reference aircraft within the spatial region, in response to validating the abnormal altitude variation prediction; determining proximity of the at least one reference aircraft to the prospective segment of the flight path; and generating the predicted CAT output based on determining that the proximity satisfies a proximity threshold.

In some embodiments, validating the abnormal altitude variation prediction comprises analyzing the spatial region for presence of one or more features in response to generating the abnormal altitude variation prediction; and generating the predicted CAT output based at least in part on determining the spatial region does not satisfy a threshold amount of the one or more features.

In some embodiments, the one or more features comprise (i) one or more environmental features or (ii) one or more weather features.

In some embodiments, generating the abnormal altitude variation prediction comprises applying the altitude dataset to a machine learning model configured to generate the abnormal altitude variation prediction by generating an altitude variation score for the at least one reference aircraft based on the altitude dataset; comparing the altitude variation score to a variation threshold; and generating the abnormal altitude variation prediction in response to determining that the altitude variation score satisfies the variation threshold.

In some embodiments, the method further comprises generating a severity classification for the at least one reference aircraft based on the altitude variation score or the altitude dataset for the at least one reference aircraft.

In some embodiments, the altitude dataset for the at least one reference aircraft comprises timeseries data for the one or more altitude parameters for the at least one reference aircraft.

In some embodiments, the one or more altitude parameters comprise one or more of (i) barometric altitude, (ii) vertical rate, or (iii) global navigation satellite system (GNSS) height above ellipsoid.

In some embodiments, initiating the performance of the one or more mitigation actions comprises generating an alert; and transmitting computer-executable instructions configured to cause display of the alert on a client computing device.

In some embodiments, initiating the performance of the one or more mitigation actions comprises transmitting computer-executable instructions configured to cause display of a visual representation of the predicted CAT within a flight plan on a client computing device, wherein the visual representation of the predicted CAT comprises a CAT volumetric severity indicator.

In some embodiments, initiating the performance of the one or more mitigation actions comprises generating one or more alternate flight path recommendations in response to the predicted CAT output; and transmitting the one or more alternate flight path recommendations to a client computing device.

In accordance with another aspect of the present disclosure, an apparatus is provided. The apparatus in some embodiments includes at least one processor and at least one non-transitory memory, the at least one non-transitory memory having computer-coded instructions stored thereon. The computer-coded instructions in execution with the at least one processor causes the apparatus to perform any of the example computer-implemented methods described herein. In some other embodiments, the apparatus includes means for performing each step of any of the computer-implemented methods described herein.

In accordance with another aspect of the present disclosure, a computer program product is provided. The computer program product in some embodiments includes at least one non-transitory computer-readable storage medium having computer program code stored thereon. The computer program code in execution with at least one processor is configured for performing any one or the example computer-implemented methods described herein.

### BRIEF DESCRIPTION OF THE DRAWINGS

Having thus described the embodiments of the disclosure in general terms, reference now will be made to the accompanying drawings, which are not necessarily drawn to scale, and wherein:

FIG. 1 illustrates an example system environment within which embodiments of the present disclosure may operate.

FIG. 2 illustrates a block diagram of an example apparatus that may be specially configured in accordance with an example embodiment of the present disclosure.

FIG. 3A illustrates an example data flow diagram of an example CAT prediction and mitigation process showing example data structures in accordance with at least one example embodiment of the present disclosure.

FIG. 3B illustrates a visualization of an example spatial region associated with a monitored aircraft in accordance with at least one example embodiment of the present disclosure.

FIG. 4 illustrates an example graphical user interface in accordance with at least one example embodiment of the present disclosure.

FIG. 5 illustrates an example graphical user interface in accordance with at least one example embodiment of the present disclosure.

FIG. 6 illustrates an example flowchart depicting example process for predicting clear air turbulence in accordance with at least one example embodiment of the present disclosure.

### DETAILED DESCRIPTION

Embodiments of the present disclosure now will be described more fully hereinafter with reference to the accompanying drawings, in which some, but not all, embodiments of the disclosure are shown. Indeed, embodiments of the present disclosure may be embodied in many different forms and should not be construed as limited to the embodiments set forth herein, rather, these embodiments are provided so that this disclosure will satisfy applicable legal requirements. The term “or” is used herein in both the alternative and conjunctive sense, unless otherwise indicated.

The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based on in part on,” “based at least on,” “based upon,” and/or similar words are used herein interchangeably in an open-ended manner such that they do not indicate being based only on or based solely on the referenced element or elements unless so indicated. Like numbers refer to like elements throughout.

It should be understood at the outset that although illustrative implementations of one or more aspects are illustrated below, the disclosed systems, apparatuses, methods, and computer program products may be implemented using any number of techniques, whether currently known or not yet in existence. The disclosure should in no way be limited to the illustrative implementations, drawings, and techniques illustrated below, but may be modified within the scope of the appended claims along with their full scope of equivalents. While values for dimensions of various elements may be disclosed, the drawings may not be to scale.

### Overview and Technical Improvements

Various embodiments of the present disclosure address technical challenges related to predicting clear air turbulence (CAT). Clear Air Turbulence (CAT) can cause sudden and unexpected altitude variation for an aircraft in cruise, potentially causing passenger injuries and even structural damage to the airframe. CAT is a major concern, particularly because of the difficulty to detect.

CAT is not detectable using the existing detection techniques and systems. Embodiments of the present disclosure provide systems, apparatuses, methods, and computer products that address the challenges and deficiencies with existing techniques and systems by capturing and leveraging altitude data associated with adjacent aircrafts relative to a monitored aircraft to accurately and in real-time predict CAT along the flight path of the monitored aircraft.

Example embodiments, analyze multiple altitude data associated with the adjacent aircrafts to detect whether an adjacent aircraft in the proximity of the flight path of the monitored aircraft is associated with abnormal altitude variation indicative of CAT in the flight path of the monitored aircraft. By continuously monitoring multiple altitude data associated with adjacent aircrafts in a specific spatial region (e.g., specific volume) to detect abnormal altitude variation (e.g., attitude instability) experienced by the adjacent aircrafts, example embodiments of the present disclosure provide for real-time prediction of CAT along the flight path of a monitored aircraft.

### Definitions

Many modifications and other embodiments of the disclosure set forth herein will come to mind to one skilled in the art to which this disclosure pertains having the benefit of the teachings presented in the foregoing description and the associated drawings. Therefore, it is to be understood that the embodiments are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments, or it may be excluded.

As used herein, the terms “data,” “content,” “information,” and similar terms may be used interchangeably to refer to data capable of being transmitted, received, or stored in accordance with embodiments of the present disclosure. Thus, use of any such terms should not be taken to limit the spirit and scope of embodiments of the present disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, or the like, sometimes referred to herein as a “network.” Similarly, where a computing device is described herein to send data to another computing device, it will be appreciated that the data may be sent directly to another computing device or may be sent indirectly via one or more intermediary computing devices, such as, for example, one or more servers, relays, routers, network access points, base stations, hosts, or the like.

As used herein, the term “circuitry” refers to particular hardware configured to perform the functions associated with the particular circuitry as described herein. In some embodiments, circuitry may be used as part of (a) hardware-only circuit implementations (e.g., implementations in analog circuitry or digital circuitry); (b) combinations of circuits and computer program product(s) comprising software or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. In some embodiments, “circuitry” may include processing circuitry, storage media, network interfaces, input/output devices, or the like. As a further example, as used herein, the term “circuitry” also includes an implementation comprising one or more processors or portion(s) thereof and accompanying software or firmware. As another example, the term “circuitry” as used herein also includes, for example, a baseband integrated circuit or applications processor integrated circuit for a mobile phone or a similar integrated circuit in a server, a cellular network device, other network device, or other computing device.

As used herein, a “computer-readable storage medium,” refers to a physical storage medium (e.g., volatile, or non-volatile memory device), and may be differentiated from a “computer-readable transmission medium,” which refers to an electromagnetic signal. A computer-readable storage medium may be a non-transitory medium.

As used herein, the terms “data structure,” “data object,” or “data set” refer interchangeably to data capable of being transmitted, received, or stored. For example, a predicted asset may be associated with one or more data elements or values in a computer-readable storage medium or computer-readable transmission medium, that represents content that is configured for use or display by one or more software applications, services, microservices, or the like.

As used herein, the terms “application,” “software application,” “app,” “computer program,” “service,” or similar terms refer to a computer program or group of computer programs designed to perform coordinated functions, tasks, or activities. Such computer programs may be operated by or for the benefit of a user or group of users. An application may be configured to provide access to one or more services provided by an entity. For example, an application may be configured to provide access to services provided by visual media content provider systems. An application may run on a server or group of servers, such as, but not limited to, web servers and application servers. In some embodiments, an application may be run on or across one or more other computing devices (e.g., user devices). For example, an application may be configured to be accessed via a web browser (e.g., a website accessed via the Internet using a browser), a dedicated client running on a user device, or the like. In some examples, an application may be configured for use by and interaction with one or more local, networked or remote computing devices.

The term “client computing device,” “client device” “client computing entity” and similar terms may be used interchangeably to refer to a computer comprising at least one processor and at least one memory. In some embodiments, the client computing device may further comprise one or more of: a display device for rendering one or more of a graphical user interface, a vibration motor for a haptic output, a speaker for an audible output, a mouse, a keyboard or touch screen, a global position system (GPS) transmitter and receiver, a radio transmitter and receiver, a microphone, a camera, a biometric scanner (e.g., a fingerprint scanner, an eye scanner, a facial scanner, etc.), or the like. Additionally, the term “client computing device” and the aforementioned similar terminology may refer to computer hardware or software that is configured to access a service or functionality offered by a system such as computing system 101 described herein, for example, a service or functionality that is made available by a server. Such a server may be in a different location or another computing system, in which case the client computing device may access the server by way of a network. Client computing devices may include, without limitation, smart phones, tablet computers, kiosk, terminal, laptop computers, wearables, personal computers, enterprise computers, or the like. Client computing devices, as described herein, may communicate with or otherwise access a computing system 101, via one or more networks. In some embodiments, the at least one processor and the at least one memory need not be physically co-located with other elements of the client computing device (e.g., in a terminal environment, in which a display may be separated from a server-based processor or memory).

In some embodiments, a client computing device may be associated with a particular operator. For example, a client computing device may be operated by a pilot of an aircraft and embodied by a computer on the aircraft, pilot’s computer, pilot’s smartphone, or the like. In some embodiments, a client computing device may be a general purpose computing device having special purpose computer programming stored or executed thereon (e.g., a program, application, or web browser session running on a personal computer or smartphone). In some embodiments, a client computing device may be configured as a terminal or other remote viewing apparatus configured to display graphical user interfaces and associated information generated on a remote computing device. In some embodiments, a client computing device may be a special purpose computing device configured to perform the various functions described herein. Various embodiments of client computing devices may include, without limitation, smartphones, tablets, laptops, terminals, kiosks, personal computers, desktop computers, enterprise computers, or the like. Various embodiments of client computing devices may operate using different operating systems including, without limitation, IOS, ANDROID, WINDOWS, MACOS, LINUX, CHROME OS, or the like.

As used herein, the term “graphical user interface” refers to a representation of a software interface. For example, a graphical user interface may be the visual representation of a software such as a website, mobile application, desktop application, or the like, that may be used to generally interface with the software. By way of example, images, buttons, links, backgrounds, text fields, or the like, may be included within or make up a graphical user interface. In various examples, a graphical user interface may be configured for display on one or more screens (e.g., a screen of a mobile phone, a personal computer, or the like).

As used herein, the term “application programming interface” and “API” refers to a computing interface that defines indication inputs between applications, services, microservices, computing devices, repositories, or the like. An API may define formatting for one or more of a programming code call, request, function, procedure, notification, data object, data structure, or the like. Non-limiting examples of an application programming interface may include JavaScript Object Notation (JSON), Extensible Markup Language (XML), Simple Object Access Protocol (SOAP), Hypertext Markup Language (HTML), the like, or combinations thereof.

As used herein, the term “repository,” “database,” and similar terms may be used interchangeably to refer to a computing location associated with a system where data is stored, accessed, modified, and otherwise maintained by the system. A repository may be used to store data in association with a data storage protocol or a query language. In certain embodiments, a repository may embody a data storage device or devices, a separate database server or servers, or as a combination of data storage devices and separate database servers. Further, in some embodiments, a repository may be embodied as a distributed repository such that some of the stored data is stored centrally in a location within the repository and other data stored in a single remote location or a plurality of remote locations. Alternatively, in some embodiments, a repository may be distributed over a plurality of remote storage locations only such as in a cloud storage environment.

As used herein, the term “machine learning model” refers to one or more processes, algorithms, or other data entity that describes parameters, hyper-parameters, defined operations, or defined mappings of a model that is configured to process one or more inputs in accordance with one or more trained parameters of the machine learning models in order to generate a prediction. An example of a machine learning model is a mathematically derived algorithm (MDA). An MDA may comprise any algorithm trained using training data to predict one or more outcome variables. Without limitation, an MDA, as used herein, may comprise machine learning frameworks including neural networks, deep neural networks, generative adversarial networks, convolutional neural networks, recurrent neural networks, large language models, generative pre-trained transformers (GPT), support vector machines, gradient boosts, decision trees, random forests, Markov models, adaptive Bayesian techniques, and statistical models (e.g., timeseries-based forecast models such as autoregressive models, autoregressive moving average models, or an autoregressive integrating moving average models). Additionally, and without limitation, an MDA, as used in the singular, may include ensembles using multiple machine learning or statistical techniques.

### Example System Architecture

Various embodiments of the present disclosure may be implemented as methods, apparatus, systems, computing devices, computer program products, or the like. As such, embodiments of the present disclosure may take the form of an apparatus, system, computing device, computing entity, or the like executing instructions stored on a computer-readable storage medium to perform certain steps or operations. Thus, embodiments of the present disclosure may take the form of an entirely hardware embodiment, an entirely computer program product embodiment, or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, or apparatus, systems, computing devices, computing devices, or the like carrying out instructions, operations, steps, and similar words used interchangeably (e.g., the executable instructions, instructions for execution, program code, or the like) on a computer-readable storage medium for execution. For example, retrieval, loading, and execution of code may be performed sequentially such that one instruction is retrieved, loaded, and executed at a time. In some example embodiments, retrieval, loading, or execution may be performed in parallel such that multiple instructions are retrieved, loaded, or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

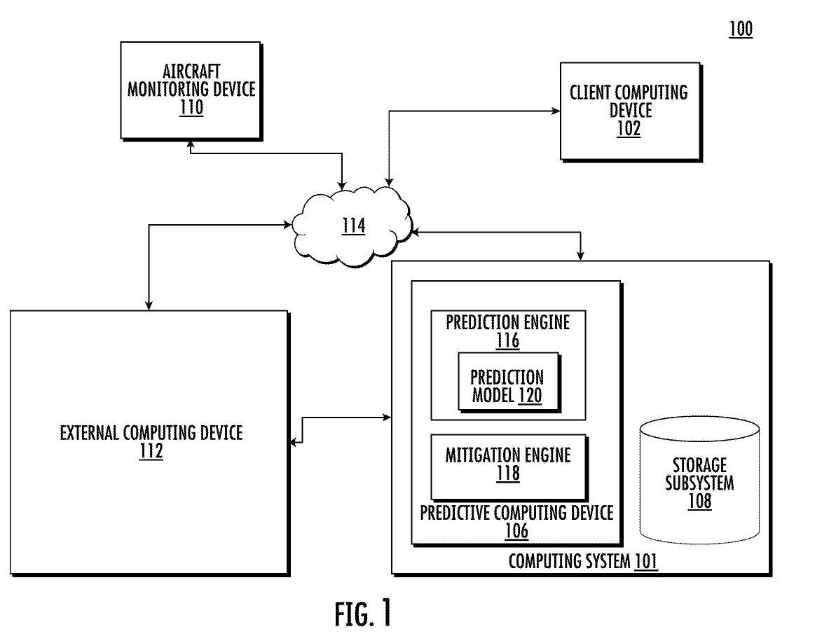

In this regard, FIG. 1 shows an example system environment 100 within which at least some embodiments of the present disclosure may operate. The depiction of the example system environment 100 is not intended to limit or otherwise confine the embodiments described and contemplated herein to any particular configuration of elements or systems, nor is it intended to exclude any alternative configurations or systems for the set of configurations and systems that can be used in connection with embodiments of the present disclosure. Rather, FIG. 1 and the system environment 100 disclosed therein is merely presented to provide an example basis and context for the facilitation of some of the features, aspects, and uses of the methods, apparatuses, computer readable media, and computer program products disclosed and contemplated herein.

The system environment 100 comprises a computing system 101 configured to generate a predicted clear air turbulence (CAT) output along a flight path of a monitored aircraft. In various embodiments, the computing system 101 is configured to initiate the performance of one or more mitigation actions in response to predicting clear air turbulence along a flight path. In some embodiments, the computing system 101 may leverage one or more machine learning models to generate predicted CAT output along a flight path. The example system environment 100 may be used in a plurality of domains and not limited to any specific application as disclosed herewith.

In some embodiments, the computing system 101 may communicate with one or more client computing devices 102, one or more aircraft monitoring computing devices 110, and/or one or more external computing devices 112 using one or more communication networks. Examples of communication networks comprise any wired or wireless communication network including, for example, a wired or wireless local area network (LAN), personal area network (PAN), metropolitan area network (MAN), wide area network (WAN), or the like, as well as any hardware, software, or firmware required to implement it (such as, e.g., network routers, or the like).

In some embodiments, the computing system 101 comprises a predictive computing device 106 (e.g., one or more servers) configured to perform various functions of the computing system 101. The predictive computing device 106 may be configured to communicate with one or more client computing devices 102, one or more aircraft monitoring computing devices 110, and/or one or more external computing devices 112. In some embodiments, two or more of the predictive computing device 106, client computing device(s) 102, aircraft monitoring computing device(s) 110 or external computing device(s) 112 may communicate using one or more wired or wireless communication techniques such as for example network 114. In some embodiments, two or more of the predictive computing device 106, client computing device(s) 102, aircraft monitoring computing device(s) 110, or external computing device(s) 112 may be embodied by an aircraft system. For example, in some embodiments, the computing system 101 is embodied by an aircraft system. In one example embodiment, the computing system 101 or two or more of the predictive computing device 106, client computing device(s) 102, aircraft monitoring computing device 110, or external computing device(s) 112 is embodied by an aircraft system.

In some embodiments, a computing device, such as a predictive computing device 106 or external computing device 112 may comprise one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, or any combination of devices or entities adapted to perform the functions, operations, or processes described herein. Such functions, operations, or processes may comprise, for example, transmitting, receiving, operating on, processing, displaying, storing, determining, creating/generating, training one or more machine learning models or generative AI models, monitoring, evaluating, comparing, or similar terms used herein interchangeably. In some embodiments, these functions, operations, or processes may be performed on data, content, information, or similar terms used herein interchangeably. In various embodiments, the predictive computing device 106 is configured to perform an autonomous CAT prediction process, as described herein.

The predictive computing device 106 may comprise or otherwise may be associated with a storage subsystem 108 that may be configured to store input data, training data, or the like that may be used by the predictive computing device 106 to perform predictive data analysis or training operations of the present disclosure. In addition, the storage subsystem 108 may be configured to store model definition data used by the predictive computing devices 106 to perform various predictive data processing or training tasks. The storage subsystem 108 may comprise one or more storage units, such as multiple distributed storage units that are connected through a computer network. A storage unit in the storage subsystem 108 may store at least one of one or more data assets or a set of data about the computed properties of one or more data assets. Moreover, each storage unit in the storage subsystem 108 may comprise one or more non-volatile storage or volatile storage media similar to or different than the non-volatile or volatile computer-readable storage media discussed above.

The predictive computing device 106 may be configured according to the techniques described herein to perform one or more operations of one or more techniques described herein. By way of example, the predictive computing device 106 may be configured to train, implement, use (e.g., execute an inference operation(s)), update (e.g., fine-tune), and evaluate machine learning models (e.g., prediction models) in accordance with one or more training or inference operations of the present disclosure.

In some example embodiments, the predictive computing device 106 may be configured to receive or transmit one or more datasets, objects, or the like from or to the external computing devices 112 and/or aircraft monitoring computing device 110 to perform one or more steps/operations of one or more techniques (e.g., data retrieval techniques or predictive data analysis techniques) described herein. The external computing devices 112 and/or aircraft monitoring computing device 110, for example, may comprise or be associated with one or more devices that may be configured to receive, transmit, store, manage, or facilitate datasets, or the like. The external computing device(s) 112 and/or the monitoring device(s) 110, for example, may comprise data sources that may provide such datasets, or the like to the predictive computing device 106 which may leverage the datasets, such as altitude data, vertical rated data, wind data, environmental data, model data, training data, or the like to perform one or more steps/operations of the present disclosure, as described herein.

In some examples, the datasets may comprise an aggregation of data from across a plurality of external computing devices 112 and/or aircraft monitoring computing devices 110 into one or more aggregated datasets. The external computing devices 112 and/or aircraft monitoring computing devices 110, for example, may be associated with one or more data repositories, cloud platforms, compute nodes, organizations, or the like, which may be individually or collectively leveraged by the predictive computing device 106 to obtain and aggregate data which may be used in one or more steps/operations of the clear air turbulence prediction process, described herein. In some examples, the datasets received from the external computing devices 112 may be stored in one or more databases of a storage subsystem associated with the predictive computing device 106.

In some embodiments, the one or more external computing devices 112 may be associated with one or more ground service provider systems. Examples of such ground service provider systems include, but not limited to, air traffic control systems configured to direct aircrafts through controlled airspace and/or provide advisory service, third-party systems that track and collect various flight data.

In some embodiments, the aircraft monitoring computing device 110 includes computer hardware or software configured to perform one or more functionalities associated with the aircraft monitoring computing device 110 including, but not limited to, transmitting various flight data (altitude data, position data, ground speed, and/or the like) to the predictive computing device 106. Alternatively, or additionally, the aircraft monitoring computing device 110 may be configured to transmit the various flight data to external computing devices 112 associated with air traffic control (ATC) operators. In some embodiments, the aircraft monitoring computing device 110 includes and/or leverages on or more aircraft system components (e.g., positioning system such as GPS, avionics, and/or the like) to provide the various flight data. In some examples, the aircraft monitoring computing device 110 may comprise an automatic dependent surveillance-broadcast (ADS-B) device installed on an aircraft. In some embodiments, an aircraft monitoring computing device 110 may be associated with an aircraft. For example, an aircraft monitoring computing device 110 may be installed in an aircraft or otherwise embodied by an aircraft. In some embodiments, the aircraft monitoring computing device 110 may be part of a larger system (e.g., ADS-B system or other aircraft system on board an aircraft).

In some example embodiments, the predictive computing device 106 includes a prediction engine 116 and a mitigation engine 118. Each of the prediction engine 116 and mitigation engine 118 may be configured to perform one or more functionalities of the predictive computing device 106.

The prediction engine 116 may include one or more prediction models 120 trained or configured to support or perform one or more functionalities of the predictive computing device 106 including, but not limited to, predictive data analysis tasks for generating predicted CAT outputs for monitored aircrafts. Such predictive data analysis tasks may include utilization of various techniques as described herein, including, but not limited to, data retrieval techniques and data analyzing techniques.

The mitigation engine 118 may be configured to support or perform one or more functionalities of the predictive computing device 106 including, but not limited to, performing mitigation tasks for generating alerts and/or alternate flight path recommendations. Such mitigation tasks may include utilization of various techniques as described herein, including but not limited to, analytical techniques and data transformation techniques.

A client computing device 102 may include computer hardware or software configured to perform one or more functionalities associated with the client computing device 102. In some embodiments, the client computing device 102 may be a mobile device. The mobile device may be a client computing device that is capable of being held and transported by an operator. Example mobile devices include, but not limited to, smart phones, tablet computers, laptop computers, wearables, laptop computers, elements or devices interacting with such devices (e.g., web cams, microphones, etc.), or the like. In some embodiments, a client computing device 102 may be a device owned by or otherwise assigned to the operator (e.g., a personal mobile phone, tablet, laptop, desktop computer, elements or other related devices, etc.). The client computing device 102 may use (e.g., access or install) one or more computer program products (e.g., a mobile application platform, desktop computer application platform) configured to provide one or more functionalities of the client computing device.

In some embodiments, a client computing device 102 is an electronic computing device that may be used by an operator for any of a variety of purposes including, but not limited to, one or more of sending or receiving signals, storing data, displaying data, viewing data, transmitting data, receiving data, or the like. For example, a client computing device 102 may be capable of, but not limited to, one or more of displaying graphical user interfaces and other graphical representations on the screens of the client computing device 102, receiving operator input, and/or the like.

It will be understood that while many of the aspects and elements presented in FIG. 1 are shown as discrete, separate elements, other configurations may be used in connection with the methods, apparatuses, computer readable media, and computer programs described herein, including configurations that combine, omit, separate, or add aspects or elements. The various functions of the system environment 100 may be performed by other arrangements of one or more computing devices or computing systems without departing from the scope of the present disclosure. For example, in some embodiments, the functions of one or more of the illustrated elements in FIG. 1 may be performed by a single computing device or by multiple computing devices, which devices may be local or cloud based.

It will be appreciated that the various functions performed by two or more of the predictive computing device 106, external computing device 112, or client computing device 102 may be embodied by a single apparatus, subsystem, or system comprising one or more sets of computing hardware (e.g., processor(s) and memory) configured to perform various functions thereof. In some embodiments, one or more intermediary devices may be positioned in electrical communication between the depicted system elements (e.g., connection between computing devices may be facilitated by various intermediary networking hardware or software elements).

In some embodiments, two or more of the depicted computing devices or computing systems may be part of a single system or device. For example, the client computing device 102 and predictive computing device 106 may be part of the same local networked system or part of the same computing system (e.g., predictive computing device 106 may be a terminal or other front end portion associated with the computing system 101 or a larger system that includes both the predictive computing device 106 and the client computing device 102). In some embodiments, two or more of the depicted devices or computing systems may be physically or electronically remote from each other (e.g., connected via the Internet).

The various elements illustrated in the system environment 100 may be configured to communicate via one or more communication mechanisms, including wired or wireless connections, such as over a network (e.g., network 114), bus, or similar connection. For example, a network may include any wired or wireless communication network including, for example, a wired or wireless local area network (LAN), personal area network (PAN), metropolitan area network (MAN), wide area network (WAN), or the like, as well as any hardware, software or firmware required to implement it (such as, e.g., network routers, etc.). For example, the network may include a cellular telephone, an 802.11, 802.16, 802.20, or WiMAX network. Further, a network may include a public network, such as the Internet, a private network, such as an intranet, or combinations thereof, and may utilize a variety of networking protocols now available or later developed including, but not limited to TCP/IP based networking protocols.

In various embodiments, the elements depicted in FIG. 1 as being included in the computing system 101, the external computing device 112, the aircraft monitoring computing device 110, the predictive computing device 106, or the client computing device 102, although not required to be an integral system, may be connected via one or more networks. In some embodiments, one or more APIs may be leveraged to communicate with or facilitate communication between one or more of the elements illustrated in the computing system 101 and system environment 100.

### Example system operations

Using the various elements and techniques described herein, the computing system 101 (e.g., predictive computing device 106 thereof) may be configured to execute a CAT prediction process configured to generate predicted CAT output and initiate performance of one or more mitigation actions based at least in part on the predicted CAT output.

In some embodiments, the computing system 101 (e.g., prediction engine 116 of the predictive computing device 106 thereof) is configured to captures altitude dataset for each of one or more reference aircrafts within a spatial region encompassing a prospective segment of a flight path for a monitored aircraft (e.g., aircraft whose flight path is being monitored by the computing system 101 for potential CAT).

In some embodiments, the computing system 101 (e.g., prediction engine 116 of the predictive computing device 106 thereof) is configured to capture the altitude datasets for the reference aircrafts by receiving the altitude dataset from one or more data sources (e.g., aircraft monitoring computing device 110 associated with the reference aircraft or one or more external computing devices 112 associated with one or more ground service systems).

In some embodiments, the computing system 101 (e.g., prediction engine 116 of the predictive computing device 106 thereof) may be configured to generate an abnormal altitude variation prediction for the reference aircrafts by analyzing each altitude dataset for variation in the altitude data set. The altitude variation score associated with a reference aircraft may be indicative and/or representative of a rate of altitude variation with respect to the reference aircraft.

In some embodiments, the computing system 101 may be configured to detect that a reference aircraft is associated with abnormal altitude variation prediction based at least in part on an altitude variation score for the reference aircraft. The computing system 101 may determine an altitude variation score for each of the one or more reference aircrafts by analyzing the altitude dataset for the respective reference aircraft. The computing system may be configured to generate abnormal altitude variation prediction for a reference aircraft based at least in part on determining that the altitude variation score satisfies (e.g., meets or exceeds) a variation threshold.

In some embodiments, the computing system 101 may leverage a prediction model 120 to generate the altitude variation score or the abnormal altitude variation prediction.

In some embodiments, the computing system 101 may be configured to analyze the spatial region for the presence and/or proximity to one or more features (e.g., terrain features such as mountains or high ridges; whether data such as jet streams or high ridges, or the like) in response to generating the abnormal altitude variation prediction to validate the abnormal altitude variation.

In some embodiments, the computing system 101 may be configured to determine location data for each reference aircraft associated with an abnormal altitude variation prediction 306 within the spatial region.

In some embodiments, the computing system 101 may be configured to generate a predicted CAT output in response to determining that the location data for a reference aircraft that is associated with an abnormal altitude variation prediction satisfies a proximity threshold. A predicted CAT output may be indicative and/or representative of a likelihood of CAT in the prospective segment of the flight path. In some embodiments, the predicted CAT output may comprise a sub-region within the spatial region that encompasses the reference aircraft associated with an abnormal altitude variation prediction and a location data that overlaps the prospective segment. In some embodiments, the predicted CAT output comprises a visual representation of the spatial region and an indication of the predicted CAT within the visual representation of the spatial region.

In some embodiments, the computing system 101 is configured to generate a severity classification for a reference aircraft associated with an abnormal altitude variation prediction and location data that satisfies a proximity threshold 312. In some embodiments, the computing system 101 101 (e.g., mitigation engine 118 of the predictive computing device 106) is configured to initiate the performance of one or more mitigation actions based on the predicted CAT output. In some embodiments, initiating the performance of the one or more mitigation actions comprises generating an alert and transmitting computer-executable instructions configured to cause display of the alert on a client computing device. In some embodiments, initiating the performance of the one or more mitigation actions comprises transmitting computer-executable instructions configured to cause display of a visual representation of the predicted CAT within a flight plan on a client computing device, wherein the visual representation of the predicted CAT comprises a CAT volumetric severity indicator. In some embodiment, a CAT volumetric severity indicator may be indicative and/or representative of the volume of air affected by CAT. In some embodiments, initiating the performance of the one or more mitigation actions comprises generating one or more alternate flight path recommendations, and transmitting the one or more flight path recommendations to a client computing device.

In some embodiments, generating the one or more alternate flight path recommendations comprise modifying at flight path based on a variation CAT severity classification associated with each of one or more sub-regions within the spatial region. In some embodiments, transmitting the one or more flight path recommendations comprises transmitting-computer executable instructions configured to cause display of the one or more or more alternate flight paths within a map encompassing the prospective segment of the monitored flight.

### Example Apparatuses

Having discussed example systems in accordance with the present disclosure, example apparatuses in accordance with the present disclosure will now be described.

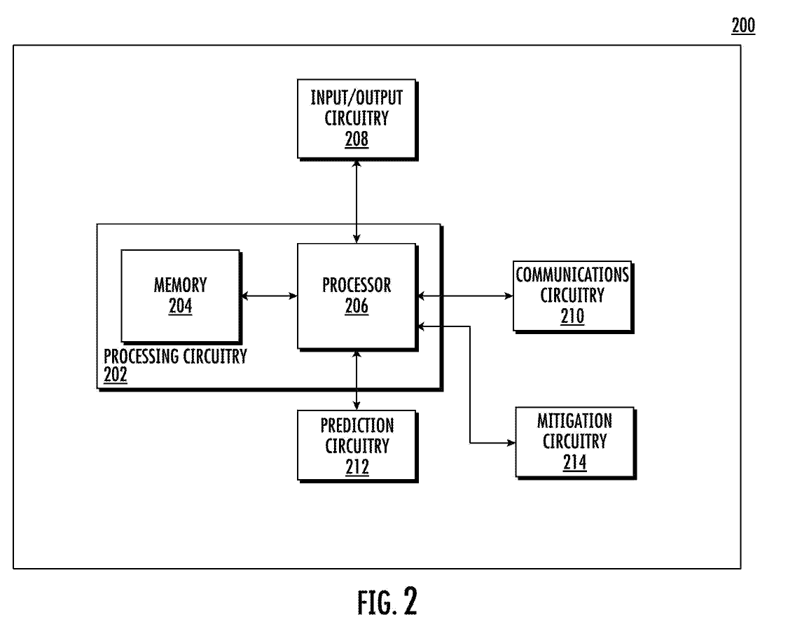

FIG. 2 illustrates a block diagram of an apparatus 200 in accordance with some example embodiments. For example, in some embodiments, the computing system 101 may be embodied by one or more apparatuses 200. In this regard, in some embodiments, the computing system 101 or one or more portions (e.g., one or more individual elements) thereof, if embodied in a particular embodiment, may be embodied by one or more apparatuses 200.

In some embodiments, the apparatus 200 may include a processing circuitry 202 as shown in FIG. 2. In some embodiments, the elements illustrated in and described with reference to FIG. 2 below may not be mandatory and thus one or more may be omitted in certain embodiments. Additionally, some embodiments, may include further or different elements beyond those illustrated in and described with reference to FIG. 2. In some embodiments, the functionality of the computing system 101 or any subset thereof may be performed by a single apparatus 200 or multiple apparatuses 200. In some embodiments, the apparatus 200 may comprise one or a plurality of physical devices, including distributed, cloud-based, or local devices.

Although some elements are described with respect to functional limitations, it should be understood that the particular implementations necessarily include the use of particular computing hardware, such as the hardware shown in FIG. 2. It should also be understood that certain of the elements described herein may include similar or common hardware. For example, two sets of circuitries for example, may both leverage use of the same processor(s), network interface(s), storage medium(s), or the like, to perform their associated functions, such that duplicate hardware is not required for each set of circuitry and a single physical circuitry may be used to perform the functions of multiple circuitries described herein. The use of the term “circuitry” as used herein with respect to elements of the apparatuses described herein should therefore be understood to include particular hardware configured to perform the functions associated with the particular circuitry as described herein.

In some embodiments, “circuitry” may include processing circuitry, storage media, network interfaces, input/output devices, or the like. In some embodiments, other elements of the apparatus 200 may provide or supplement the functionality of another particular set of circuitry. For example, the processor 206 in some embodiments provides processing functionality to any of the sets of circuitries, the memory 204 provides storage functionality to any of the sets of circuitry, the communications circuitry 210 provide network interface functionality to any of the sets of circuitry, or the like.

The apparatus 200 may include or otherwise be in communication with processing circuitry 202 that is configurable to perform actions in accordance with one or more example embodiments disclosed herein. In this regard, the processing circuitry 202 may be configured to perform or control performance of one or more functionalities of the apparatus 200 in accordance with various example embodiments, and thus may provide means for performing functionalities of the apparatus 200 in accordance with various example embodiments. The processing circuitry 202 may be configured to perform data processing, application, and function execution, or other processing and management services according to one or more example embodiments. In some embodiments, the apparatus 200 or a portion(s) or elements(s) thereof, such as the processing circuitry 202, may be embodied as or comprise a chip or chip set. In other words, apparatus 200 or the processing circuitry 202 may comprise one or more physical packages (e.g., chips) including materials, elements or wires on a structural assembly (e.g., a baseboard). The structural assembly may provide physical strength, conservation of size, or limitation of electrical interaction for element circuitry included thereon. The apparatus 200 or the processing circuitry 202 may therefore, in some cases, be configured to implement an embodiment of the disclosure on a single chip or as a single “system on a chip.” As such, in some cases, a chip or chipset may constitute means for performing one or more operations for providing the functionalities described herein.

In some embodiments, the processing circuitry 202 may include a processor 206 (or co-processor or any other processing circuitry assisting or otherwise associated with the processor) and, in some embodiments, such as that illustrated in FIG. 2, may further include memory 204. The processing circuitry 202 may be in communication with or otherwise control a user interface (e.g., embodied by input/output circuitry 208) or a communications circuitry 210. As such, the processing circuitry 202 may be embodied as a circuit chip (e.g., an integrated circuit chip) configured (e.g., with hardware, software or a combination of hardware and software) to perform operations described herein.

The processor 206 may be embodied in a number of different ways. For example, the processor 206 may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. Although illustrated as a single processor, it will be appreciated that the processor 206 may comprise a plurality of processors. The plurality of processors may be in operative communication with each other and may be collectively configured to perform one or more functionalities of the apparatus 200 as described herein. In some example embodiments, the processor 206 may be configured to execute instructions stored in the memory 204 or otherwise accessible to the processor 206. As such, whether configured by hardware or by a combination of hardware and software, the processor 206 may represent an entity (e.g., physically embodied in circuitry – in the form of processing circuitry 202) capable of performing operations according to embodiments of the present disclosure while configured accordingly. Thus, for example, when the processor 206 is embodied as an ASIC, FPGA or the like, the processor 206 may be specifically configured hardware for conducting the operations described herein. Alternatively, as another example, when the processor 206 is embodied as an executor of software instructions, the instructions may specifically configure the processor 206 to perform one or more operations described herein. The use of the terms “processor” and “processing circuitry” may be understood to include a single core processor, a multi-core processor, multiple processors internal to the apparatus 200, or one or more remote or “cloud” processor(s) external to the apparatus 200.

In some example embodiments, the memory 204 may include one or more non-transitory memory devices such as, for example, volatile or non-volatile memory that may be either fixed or removable. In this regard, the memory 204 may comprise a non-transitory computer-readable storage medium. It will be appreciated that while the memory 204 is illustrated as a single memory, the memory 204 may comprise a plurality of memories. The memory 204 may be configured to store information, data, applications, instructions or the like for enabling the apparatus 200 to carry out various functions in accordance with one or more example embodiments. For example, the memory 204 may be configured to buffer input data for processing by the processor 206. Additionally, or alternatively, the memory 204 may be configured to store instructions for execution by the processor 206. The memory 204 may include one or more databases that may store a variety of files, contents, or data sets. Among the contents of the memory 204, applications may be stored for execution by the processor 206 in order to carry out the functionality associated with each respective application. In some cases, the memory 204 may be in communication with one or more of the processors 206, input/output circuitry 208 or communications circuitry 210, via a bus(es) for passing information among elements of the apparatus 200.

The input/output circuitry 208 may provide output to the user or an intermediary device and, in some embodiments, may receive one or more indication(s) of user input directly or indirectly. In some embodiments, the input/output circuitry 208 is in communication with processor 206 to provide such functionality. The input/output circuitry 208 may include one or more user interface(s) or include a display that may comprise the user interface(s) rendered as a web user interface, an application interface, or the like, to the display of a client computing device, a backend system, or the like. The input/output circuitry 208 may be in communication with the processing circuitry 202 to receive an indication of a user input at the user interface or to provide an audible, visual, mechanical, or other output to the user. As such, the input/output circuitry 208 may include, for example, a keyboard, a mouse, a joystick, a display, a touch screen display, a microphone, a speaker, or other input/output mechanisms. As such, the input/output circuitry 208 may, in some example embodiments, provide means for a user to access and interact with the apparatus 200. The processor 206 or input/output circuitry 208 comprising or otherwise interacting with the processor 206 may be configured to control one or more functions of one or more user interface elements through computer program instructions (e.g., software or firmware) stored on a memory accessible to the processor 206 (e.g., stored on memory 204, or the like).

The communications circuitry 210 may include one or more interface mechanisms for enabling communication with other devices or networks. In some cases, the communications circuitry 210 may comprise any means such as a device or circuitry embodied in either hardware, or a combination of hardware and software that is configured to receive or transmit data from/to a network or any other device or module in communication with the processing circuitry 202. The communications circuitry 210 may, for example, include an antenna (or multiple antennas) and supporting hardware or software for enabling communications with a wireless communication network (e.g., a wireless local area network, cellular network, global positioning system network, or the like) or a communication modem or other hardware/software for supporting communication via cable, digital subscriber line (DSL), universal serial bus (USB), Ethernet or other methods.

In some embodiments, the apparatus 200 may include a prediction circuitry 212 which may include hardware elements, with or without enabling software elements, firmware elements, or a combination thereof configured to, with the processing circuitry 202, input/output circuitry 208 or communications circuitry 210, perform one or more functions associated with the predictive computing device 106 (as described above with reference to FIG. 1), particularly the prediction engine 116. For example, the prediction circuitry 212 may access, facilitate access, receive, process, manipulate, provide, or otherwise use, or make available for use, certain data (e.g., altitude data, vertical data, wind data, or other data) used by one or more other elements of the apparatus 200 through, for example, the use of hardware, software, applications, or APIs executed using a processor, such as the processor 206. In some embodiments, the prediction circuitry 212 may interact with the memory 204, which may store the aforementioned data. It should also be appreciated that, in some embodiments, the prediction circuitry 212 may include a separate processor, specially configured field programmable gate array (FPGA), or application specific interface circuit (ASIC) to receive such data utilized by the prediction circuitry 212. The prediction circuitry 212 may also provide for communication with other elements of the apparatus 200, system or external systems via a network interface provided by the communications circuitry 210. In some embodiments, one or more portions of the prediction circuitry 212 and processing circuitry 202 may be integrated into a single circuitry or group of circuitries, with or without various other circuitries discussed herein, configured to execute the respective functionalities thereof.

In some embodiments, the apparatus 200 may include a mitigation circuitry 214 which may include hardware elements, with or without enabling software elements, firmware elements, or a combination thereof configured to, with the processing circuitry 202, input/output circuitry 208 or communications circuitry 210, perform one or more functions associated with the predictive computing device 106 (as described above with reference to FIG. 1), particularly the mitigation engine 118. For example, the mitigation circuitry 214 may access, facilitate access, receive, process, manipulate, provide, or otherwise use, or make available for use, certain data (e.g., altitude data, vertical data, wind data, or other data) used by one or more other elements of the apparatus 200 through, for example, the use of hardware, software, applications, or APIs executed using a processor, such as the processor 206. In some embodiments, the mitigation circuitry 214 may interact with the memory 204, which may store the aforementioned data. It should also be appreciated that, in some embodiments, the mitigation circuitry 214 may include a separate processor, specially configured field programmable gate array (FPGA), or application specific interface circuit (ASIC) to receive such data utilized by the mitigation circuitry 214. The mitigation circuitry 214 may also provide for communication with other elements of the apparatus 200, system or external systems via a network interface provided by the communications circuitry 210. In some embodiments, one or more portions of the mitigation circuitry 214 and processing circuitry 202 may be integrated into a single circuitry or group of circuitries, with or without various other circuitries discussed herein, configured to execute the respective functionalities thereof.

The mitigation circuitry 214 may include software or a combination of hardware and software that supports various functionality associated with one or more prediction models. For example, in some embodiments, the mitigation circuitry 214 includes hardware, software, firmware, or a combination thereof, that performs predictive data analysis to generate a predicted CAT output along a flight path of an aircraft by utilizing one or more prediction models.

In this regard, FIG. 1 shows an example system environment 100 within which at least some embodiments of the present disclosure, including apparatus(es) 200, may operate. The depictions of the example system environment 100 and apparatus 200 are not intended to limit or otherwise confine the embodiments described and contemplated herein to any particular configuration of elements or systems, nor are they intended to exclude any alternative configurations or systems for the set of configurations and systems that can be used in connection with embodiments of the present disclosure. Rather, FIGS. 1-2 and the system environment 100 and apparatus(es) 200 disclosed therein are merely presented to provide an example basis and context for the facilitation of some of the features, aspects, and uses of the methods, apparatuses, computer readable media, and computer program products disclosed and contemplated herein. As noted above, in some embodiments, the predictive computing device 106 may be embodied by one or more apparatuses 200 shown in FIG. 2 or portions thereof relevant to the functions of the respective devices.

### Example Data Flows and Data Structures of the Disclosure

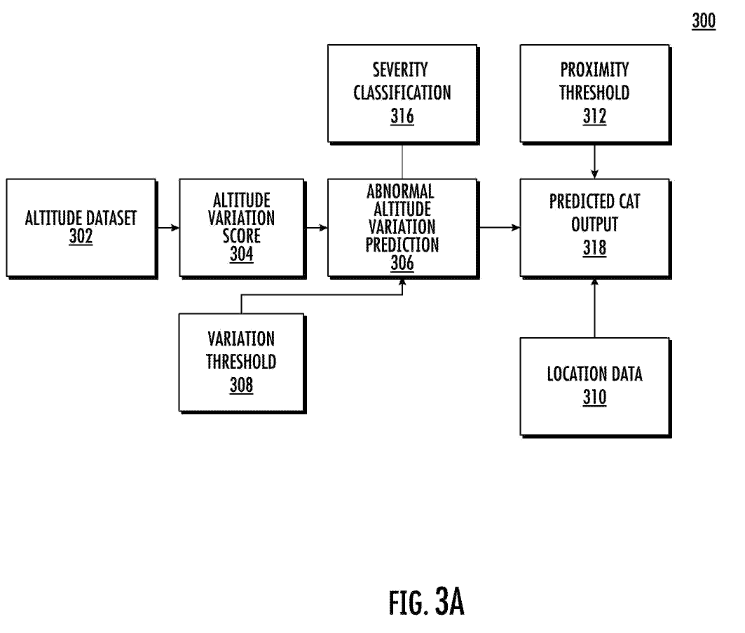

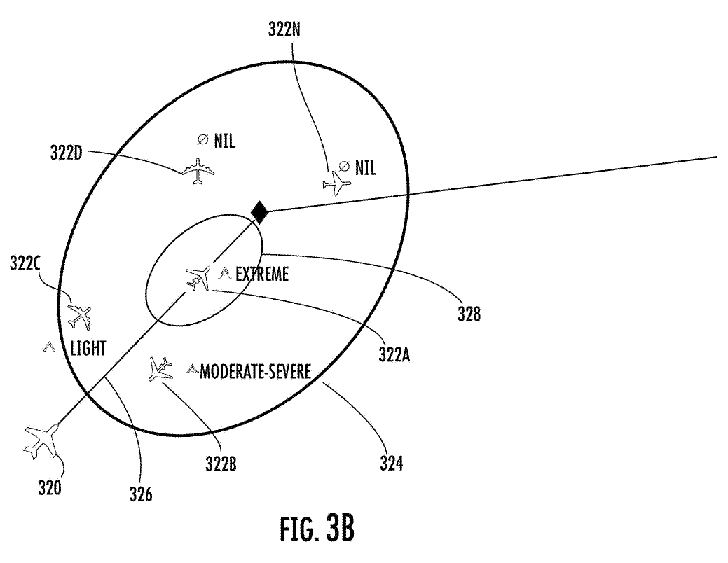

Having described example systems and apparatuses in accordance with the present disclosure, example data flows and data structures will now be discussed. FIG. 3A is an example data flow 300 presented in in accordance with at least one example embodiment of the present disclosure. In some example embodiments, the data structures and processes shown and described with reference to the data flow diagram of FIG. 3A may be generated, performed, or otherwise facilitated by the various systems and apparatuses shown and described with reference to FIGS. 1-2. Specifically, FIG. 3A represents an example data flow of a CAT prediction in accordance with at least one example embodiment of the present disclosure. FIG. 3B illustrates a visualization of a spatial region in accordance with at least one example embodiments of the present disclosure.

In some embodiments, the computing system 101 captures altitude dataset 302 for each of one or more reference aircrafts 322A-N within a spatial region 324 encompassing a prospective segment 326 of a flight path for a monitored aircraft 320.

In some embodiments, the monitored aircraft 320 comprises an aircraft that is the subject of a CAT prediction process, as described herein. For example, the monitored aircraft 320 may comprise an aircraft whose flight path is being monitored by the computing system 101 for potential CAT.

In some embodiments, a flight path comprises a planned trajectory (e.g., route, course, or similar terms) for an aircraft to follow for a specific journey from one location to another location. In some embodiments, a prospective segment 326 of a flight path comprises a portion of the flight path (e.g., planned trajectory) ahead of the monitored aircraft 320 (e.g., that has not been traveled by the monitored aircraft 320) at the current time. For example, the prospective segment 326 of the flight path may comprise a portion of the flight path that spans a distance (e.g., predetermined distance) ahead and along the flight path from the current location of the monitored aircraft 320.

In some embodiments, a spatial region 324 comprises a predefined area around the prospective segment 326 of the flight path. For example, the spatial region 324 may comprise a volume of airspace ahead of the current location of the monitored aircraft 320 and that encompasses the prospective segment 326 of the flight path for the monitored aircraft.

In some embodiments, a reference aircraft comprises an adjacent aircraft (e.g., neighbor aircraft) relative to the monitored aircraft 320. For example, a reference aircraft may comprise an aircraft that is within a predefined distance from the monitored aircraft 320.

In some embodiments, the altitude dataset 302 for a reference aircraft comprises data for one or more altitude parameters with respect to the reference aircraft. In some embodiments, the altitude dataset 302 may be a timeseries altitude dataset. For example, the altitude dataset 302 may comprise timeseries data for the one or more monitored altitude parameters. For example, the data for a given altitude parameter in the altitude dataset 302 may comprise measured and/or collected data points for the given altitude parameter over a period of time and that is arranged sequentially. For example, each data point may be associated with a timestamp. In some embodiments, the period of time corresponds to at least a portion of the time in which the reference aircraft is within the spatial region 324.

In some embodiments, the one or more monitored altitude parameters comprise barometric altitude and/or global navigation satellite system (GNSS) height above ellipsoid. Additionally, in some embodiments, the one or more altitude parameters comprise vertical rate, headings, groundspeed, and/or winds.

In some embodiments, the computing system 101 captures the altitude dataset 302 for a reference aircraft by receiving the altitude dataset 302 from one or more data sources. In some embodiments, the computing system 101 may receive the altitude dataset 302 (or portion thereof) for a reference aircraft from an aircraft monitoring computing device 110 associated with the reference aircraft. Alternatively, or additionally, the computing system 101 may receive the altitude dataset 302 (or portion thereof) for a reference aircraft from one or more external computing devices 112 associated with one or more ground service systems.

In some embodiments, the computing system 101, generates an abnormal altitude variation prediction 306 for at least one reference aircraft of the one or more reference aircrafts by analyzing the altitude dataset 302 for the at least one reference aircraft for variation in the altitude data set 302. For example, the computing system 101 may analyze the altitude dataset 302 for each reference aircraft to determine if the respective altitude dataset 302 is associated with abnormal altitude variation prediction 306. In some embodiments, the computing system 101 leverages a prediction model 120 to generate the abnormal altitude variation prediction 306. For example, the computing system 101 may apply the altitude dataset to a prediction model configured to generate the abnormal altitude variation prediction 306. In some embodiments, the prediction model is a machine learning model.

The altitude variation score 304 associated with a reference aircraft may be indicative and/or representative of a rate of altitude variation with respect to the reference aircraft. For example, the altitude variation score 304 for a reference aircraft may comprise a measure of a rate of variation of the altitude parameter(s) of the reference aircraft.

In some embodiments, the computing system 101 may detect that a reference aircraft is associated with abnormal altitude variation prediction 306 based at least in part on an altitude variation score 304 for the reference aircraft. The computing system 101 may calculate or otherwise determine an altitude variation score 304 for each of the one or more reference aircrafts 322A-N by analyzing the altitude dataset 302 for the respective reference aircraft. The computing system 101 may compare the altitude variation score 304 associated with a reference aircraft to a variation threshold 308. The computing system 101 may detect abnormal altitude variation prediction 306 in the altitude dataset 302 for a reference aircraft based at least in part on determining that the altitude variation score 304 satisfies (e.g., meets or exceeds) a variation threshold.

The altitude variation score 304 associated with a reference aircraft may be indicative and/or representative of a rate of altitude variation with respect to the reference aircraft. For example, the altitude variation score 304 for a reference aircraft may comprise a measure of a rate of variation of the altitude parameter(s) of the reference aircraft.

In some embodiments, the computing system 101 analyzes the spatial region 324 for the presence of one or more features in response to generating the abnormal altitude variation prediction 306 to validate the abnormal altitude variation. The one or more features may comprise CAT formation features. In some embodiments, the computing system 101 validates the predicted CAT output based at least in part on determining the spatial region does not satisfy a threshold amount of the one or more features. In some embodiments, the one or more features comprise one or more environmental features and/or one or more weather features. In some embodiments, the one or more environmental features comprise terrain features such as mountains or high ridges. In some embodiments, the one or more weather features comprise jet steams or high-altitude wind currents.

In some embodiments, the computing system 101 determines location data 310 for a reference aircraft associated with an abnormal altitude variation prediction 306. For example, for each reference aircraft associated with an abnormal altitude variation prediction 306, the computing system 101 may determine the location data 310 for the reference aircraft within the spatial region. The location data 310 for a reference aircraft may be indicative and/or representative of a location of the reference aircraft within the spatial region 324.

In some embodiments, the computing system 101 generates a predicted CAT output 318 in response to determining that the location data 310 for a reference aircraft (e.g., reference aircraft 322A) associated with an abnormal altitude variation prediction 306 satisfies a proximity threshold 312. A predicted CAT output 318 may be indicative and/or representative of a likelihood of CAT in the prospective segment 326 of the flight path. The predicted CAT output 318 may comprises a sub-region 328 within the spatial region 324 that encompasses the reference aircraft (e.g., reference aircraft 322A) associated with an abnormal altitude variation prediction 306 and a location data that overlaps the prospective segment 326. In some embodiments, the predicted CAT output comprises a visual representation of the spatial region and an indication of the predicted CAT within the visual representation of the spatial region.

In some embodiments, the computing system 101, generates a severity classification 316 for at least the reference aircraft associated with an abnormal altitude variation prediction 306 and location data 310 that satisfies a proximity threshold 312. In some embodiments, the computing system 101 may generate a severity classification 316 for each reference aircraft associated with a validated abnormal altitude variation prediction. In some embodiments, the severity classification 316 is indicative and/or representative of a measure of the intensity of the predicted CAT. For example, the severity classification 316 may be determined by determining the eddy dissipation rate (EDR) for the reference aircraft based on the altitude variation score 304 and/or altitude dataset 302 for the at least one reference aircraft. In some embodiments, the altitude variation score 304 corresponds to the eddy dissipation rate.

In some embodiments, the computing system 101 may leverage the prediction model 120 to generate the altitude variation score 304, abnormal altitude variation prediction 306, and/or predicted output 318. For example, in some embodiments, the computing system 101 leverages a prediction model 120 to generate the abnormal altitude variation prediction 306 as describe above. For example, the prediction model 120 may be configured to generate the altitude variation score for at least one reference aircraft based on the altitude dataset; compare the altitude variation score to a variation threshold; and generate the abnormal altitude variation prediction in response to determining that the altitude variation score satisfies the variation threshold.

In some embodiments, the computing system 101 initiates the performance of one or more mitigation actions based on the predicted CAT output. In some embodiments, initiating the performance of the one or more mitigation actions comprises generating an alert and transmitting computer-executable instructions configured to cause display of the alert on a client computing device.

In some embodiments, initiating the performance of the one or more mitigation actions comprises transmitting computer-executable instructions configured to cause display of a visual representation of the predicted CAT within a flight plan on a client computing device, wherein the visual representation of the predicted CAT comprises a CAT volumetric severity indicator.

In some embodiments, initiating the performance of the one or more mitigation actions comprises generating one or more alternate flight path recommendations, and transmitting the one or more flight path recommendations to a client computing device. In some embodiments, generating the one or more alternate flight path recommendations comprise modifying at flight path based on a severity classification associated with each of one or more sub-regions within the spatial region.

In some embodiments, transmitting the one or more flight path recommendations comprises transmitting-computer executable instructions configured to cause display of the one or more or more alternate flight paths within a map encompassing the prospective segment of the monitored flight.

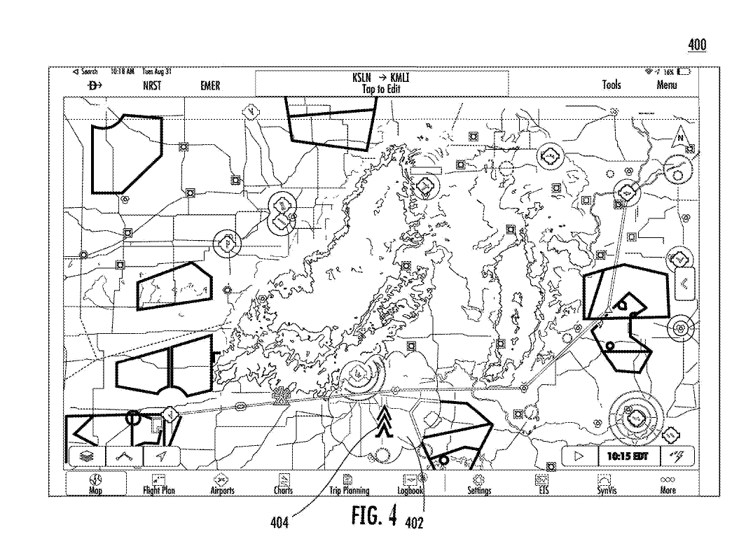

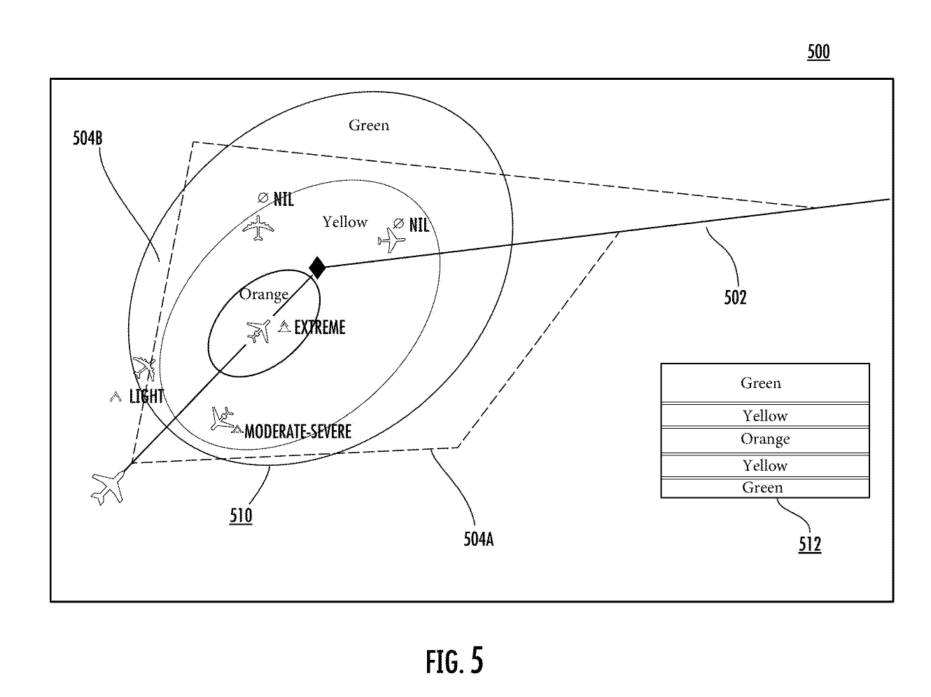

FIGS. 4 and 5 each illustrate example graphical user interface associated with the systems describe herein. Specifically, FIG. 4 illustrates a graphical user interface 400 in accordance with at least one example embodiment of the present disclosure and FIG. 5 illustrates a graphical user interface 500 in accordance with at least one example embodiment of the present disclosure. The graphical user interface 400 and graphical user interface 500 may be, for example, a graphical user interface of an application (e.g., mobile application, web application or the like) accessible via a client computing device. The graphical user interface 400 and 500 may be configured to display a visualization of predicted CAT output (e.g., representation of predicted CAT output).

As shown in FIG. 4, representation 402 of a predicted CAT output may be displayed on the graphical user interface 400. As further depicted in FIG. 4, a severity classification 404 for the predicted CAT output may be displayed on the graphical user interface within the representation 402. As shown in FIG. 5, the graphical user interface 500 may be configured to display one or more alternate flight path recommendations (e.g., 504A-B) along with the original flight path 502. As shown in FIG. 5, alternate flight path recommendation (e.g., safe flight zones) may be displayed, in both lateral view 510 and vertical view 512 to, for example, show altitude bands of 1000 or the like.

### Example Methods

Having described example systems, apparatuses, and user interfaces in accordance with the present disclosure, example processes for generating predicted CAT output will now be discussed. It will be appreciated that each of the flowcharts depicts an example computer-implemented process that is performable by one or more of the apparatuses, systems, devices, and/or computer program products described herein, for example utilizing one or more of the specially configured components thereof.

The blocks indicate operations of each process. Such operations may be performed in any of a number of ways, including, without limitation, in the order and manner as depicted and described herein. In some embodiments, one or more blocks of any of the processes described herein occur in-between one or more blocks of another process, before one or more blocks of another process, in parallel with one or more blocks of another process, and/or as a sub-process of a second process. Additionally, or alternatively, any of the processes in various embodiments include some or all operational steps described and/or depicted, including one or more optional blocks in some embodiments. With regard to the flowcharts illustrated herein, one or more of the depicted block(s) in some embodiments is/are optional in some, or all, embodiments of the disclosure. Optional blocks are depicted with broken (or “dashed”) lines. Similarly, it should be appreciated that one or more of the operations of each flowchart may be combinable, replaceable, and/or otherwise altered as described herein.

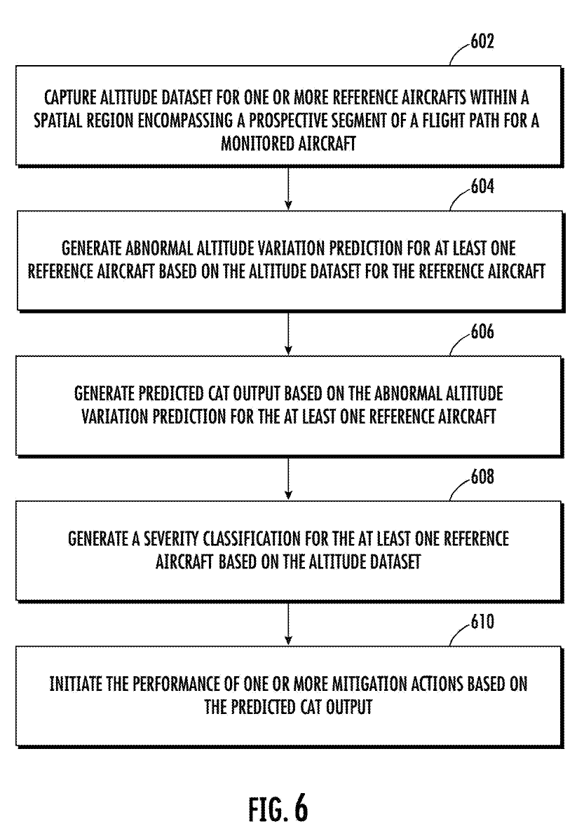

FIG. 6 illustrates an example computer-implemented process 600 for predicting clear air turbulence for an aircraft. The process 600 may be implemented by one or more computing devices, entities, or systems described herein.

In some embodiments, the process 600 is embodied by computer program code stored on a non-transitory computer-readable storage medium of a computer program product configured for execution to perform the process as depicted and described. Alternatively, or additionally, in some embodiments, the process 600 is performed by one or more specially configured computing devices, such as the apparatus 200 alone or in communication with one or more other component(s), device(s), system(s), and/or the like. In this regard, in some such embodiments, the apparatus 200 is specially configured by computer-coded instructions (e.g., computer program instructions) stored thereon, for example in the memory 204 and/or another component depicted and/or described herein and/or otherwise accessible to the apparatus 200, for performing the operations as depicted and described. For purposes of simplifying the description, the process 600 is described as performed by and from the perspective of the apparatus 200.

In some embodiments, the process 600 comprise at operation 602, capturing altitude dataset for each of one or more reference aircrafts within a spatial region encompassing a prospective segment of a flight path for a monitored aircraft. For example, the altitude dataset for each reference aircraft may comprise measured data for one or more altitude parameters. In some embodiments, the altitude dataset for the at least one reference aircraft comprises timeseries data for one or more altitude parameters for the reference aircraft. In some embodiments, the one or more altitude parameters comprise barometric altitude, vertical rate, and/or global navigation satellite system (GNSS) height above ellipsoid. Additionally, in some embodiments, the altitude dataset may include proximity data such as proximity to an airport. For example, some altitude variation may be expected near airports. In this regard, the system accounts for this expected altitude variation when predicting CAT as further describe below.

In some embodiments, the process 600 comprise at operation 604, generating abnormal altitude variation prediction for at least one reference aircraft of the one or more reference aircrafts based on the altitude dataset for the at least one reference aircraft. In some embodiments, generating the abnormal variation comprises generating an altitude variation score for the at least one reference aircraft based on the altitude dataset; comparing the altitude variation score to a variation threshold; and generating the abnormal altitude variation prediction in response to determining that the altitude variation score satisfies the variation threshold.

In some embodiments, the process 600 comprise at operation 606, generating, a predicted CAT output based on the abnormal altitude variation prediction for the at least one reference aircraft. For example, the predicted CAT output may indicate a likelihood of CAT in the prospective segment of the flight path. In some embodiments, the predicted CAT output comprises a visual representation of the spatial region and an indication of the predicted CAT within the visual representation of the spatial region.

In some embodiments, generating the predicted CAT output based on the abnormal altitude variation prediction comprises validating the abnormal altitude variation prediction; determining location data of the at least one reference aircraft within the spatial region, in response to validating the abnormal altitude variation prediction; determining the proximity of the at least one reference aircraft to the prospective segment of the flight path; and generating the predicted CAT output based on determining that the proximity satisfies a proximity threshold.

In some embodiments, validating the abnormal altitude variation prediction comprises analyzing the spatial region for the presence of one or more features in response to generating the abnormal altitude variation prediction; and generating the predicted CAT output based at least in part on determining the spatial region does not satisfy a threshold amount of the CAT formation features. In some embodiments, the one or more features comprise one or more environmental features or one or more weather features.

In some embodiments, the process 600 comprise at operation 608, generating a severity classification for the at least one reference aircraft based on the variation score or the altitude dataset for the at least one reference aircraft.

In some embodiments, the process 600 comprise at operation 610, initiating performance of one or more mitigation actions based on the predicted CAT output. In some embodiments, initiating the performance of the one or more mitigation actions comprises: generating an alert; and transmitting computer-executable instructions configured to cause display of the alert on a client computing device.

In some embodiments, the alert may be associated with a severity level that is determined based on the weight of the at least one reference aircraft 322A associated with the abnormal altitude variation relative to the weight of the monitored aircraft 320. For example, the alert may be associated with a lower severity level if the weight (e.g., medium) of monitored aircraft 320 is larger than the weight (e.g., light) of the at least one reference aircraft 322A.

In some embodiments, initiating the performance of the one or more mitigation actions comprises transmitting computer-executable instructions configured to cause display of a visual representation of the predicted CAT within a flight plan on a client computing device, wherein the visual representation of the predicted CAT comprises a CAT volumetric severity indicator.

In some embodiments, initiating the performance of the one or more mitigation actions comprises generating one or more alternate flight path recommendations in response to the predicted CAT output; and transmitting the one or more flight path recommendations to a client computing device. In some embodiments, transmitting the one or more flight path recommendations comprises transmitting-computer executable instructions configured to cause display of the one or more or more alternate flight paths within a map encompassing the prospective segment of the monitored flight.

### Conclusion

Although an example processing system has been described above, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer storage medium for execution by, or to control the operation of, information/data processing apparatus. Alternatively, or in addition, the program instructions can be encoded on an artificially-generated propagated signal, e.g., a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a repository management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user’s client device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a client computer having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
capturing, by one or more processors, altitude dataset for each of one or more reference aircrafts within a spatial region encompassing a prospective segment of a flight path for a monitored aircraft, wherein the altitude dataset for each reference aircraft comprises measured data for one or more altitude parameters;
generating, by the one or more processors, abnormal altitude variation prediction for at least one reference aircraft of the one or more reference aircrafts by analyzing the altitude dataset for the at least one reference aircraft;
generating, by the one or more processors, a predicted clear air turbulence (CAT) output based on the abnormal altitude variation prediction for the at least one reference aircraft, wherein the predicted CAT output indicates a likelihood of CAT in the prospective segment of the flight path; and
initiating, by the one or more processors, performance of one or more mitigation actions based on the predicted CAT output.

2. The computer-implemented method of claim 1, wherein generating the predicted CAT output based on the abnormal altitude variation prediction comprises:
validating the abnormal altitude variation prediction;
determining location data of the at least one reference aircraft within the spatial region, in response to validating the abnormal altitude variation prediction;
determining proximity of the at least one reference aircraft to the prospective segment of the flight path; and
generating the predicted CAT output based on determining that the proximity satisfies a proximity threshold.

3. The computer-implemented method of claim 1, wherein validating the abnormal altitude variation prediction comprises:
analyzing the spatial region for presence of one or more features in response to generating the abnormal altitude variation prediction; and
and generating the predicted CAT output based at least in part on determining the spatial region does not satisfy a threshold amount of the one or more features.

4. The computer-implemented method of claim 3, wherein the one or more features comprise (i) one or more environmental features or (ii) one or more weather features.

5. The computer-implemented method of claim 1, wherein generating the abnormal altitude variation prediction comprises applying the altitude dataset to a machine learning model configured to generate the abnormal altitude variation prediction by:
generating an altitude variation score for the at least one reference aircraft based on the altitude dataset;
comparing the altitude variation score to a variation threshold; and
generating the abnormal altitude variation prediction in response to determining that the altitude variation score satisfies the variation threshold.

6. The computer-implemented method of claim 5, further comprising generating a severity classification for the at least one reference aircraft based on the altitude variation score or the altitude dataset for the at least one reference aircraft.

7. The computer-implemented method of claim 1, wherein the altitude dataset for the at least one reference aircraft comprises timeseries data for the one or more altitude parameters for the at least one reference aircraft.

8. The computer-implemented method of claim 1, wherein the one or more altitude parameters comprise one or more of (i) barometric altitude, (ii) vertical rate, or (iii) global navigation satellite system (GNSS) height above ellipsoid.

9. The computer-implemented method of claim 1, wherein initiating the performance of the one or more mitigation actions comprises:
generating an alert; and
transmitting computer-executable instructions configured to cause display of the alert on a client computing device.

10. The computer-implemented method of claim 1, wherein initiating the performance of the one or more mitigation actions comprises:
transmitting computer-executable instructions configured to cause display of a visual representation of the predicted CAT output within a flight plan on a client computing device, wherein the visual representation of the predicted CAT output comprises a CAT volumetric severity indicator.

11. The computer-implemented method of claim 1, wherein initiating the performance of the one or more mitigation actions comprises:
generating one or more alternate flight path recommendations in response to the predicted CAT output; and
transmitting the one or more alternate flight path recommendations to a client computing device.

12. An apparatus comprising at least one processor and at least one memory storing instructions that, when executed by the at least one processor, cause the apparatus to:
capture altitude dataset for each of one or more reference aircrafts within a spatial region encompassing a prospective segment of a flight path for a monitored aircraft, wherein the altitude dataset for each reference aircraft comprises measured data for one or more altitude parameters;
generate abnormal altitude variation prediction for at least one reference aircraft of the one or more reference aircrafts by analyzing the altitude dataset for the at least one reference aircraft;
generate a predicted clear air turbulence (CAT) output based on the abnormal altitude variation prediction for the at least one reference aircraft, wherein the predicted CAT output indicates a likelihood of CAT in the prospective segment of the flight path; and
initiate performance of one or more mitigation actions based on the predicted CAT output.

13. The apparatus of claim 12, wherein generating the predicted CAT output based on the abnormal altitude variation prediction comprises:
validating the abnormal altitude variation prediction;
determining location data of the at least one reference aircraft within the spatial region, in response to validating the abnormal altitude variation prediction;
determining proximity of the at least one reference aircraft to the prospective segment of the flight path; and
generating the predicted CAT output based on determining that the proximity satisfies a proximity threshold.

14. The apparatus of claim 12, wherein validating the abnormal altitude variation prediction comprises:
analyzing the spatial region for presence of one or more features in response to generating the abnormal altitude variation prediction; and
and generating the predicted CAT output based at least in part on determining the spatial region does not satisfy a threshold amount of the one or more features.

15. The apparatus of claim 14, wherein the one or more features comprise (i) one or more environmental features or (ii) one or more weather features.

16. The apparatus of claim 12, wherein generating the abnormal altitude variation prediction comprises applying the altitude dataset to a machine learning model configured to generate the abnormal altitude variation prediction by:
generating an altitude variation score for the at least one reference aircraft based on the altitude dataset;
comparing the altitude variation score to a variation threshold; and
generating the abnormal altitude variation prediction in response to determining that the altitude variation score satisfies the variation threshold.

17. The apparatus of claim 16, wherein the apparatus is further caused to generate a severity classification for the at least one reference aircraft based on the altitude variation score or the altitude dataset for the at least one reference aircraft.

18. The apparatus of claim 12, wherein the altitude dataset for the at least one reference aircraft comprises timeseries data for one or more altitude parameters for the at least one reference aircraft.

19. The apparatus of claim 12, wherein the one or more altitude parameters comprise one or more of (i) barometric altitude, (ii) vertical rate, or (iii) global navigation satellite system (GNSS) height above ellipsoid.

20. At least one non-transitory computer-readable storage medium, the at least one non-transitory computer-readable storage medium having computer coded instructions configured to, when executed by at least one processor:
capture altitude dataset for each of one or more reference aircrafts within a spatial region encompassing a prospective segment of a flight path for a monitored aircraft, wherein the altitude dataset for each reference aircraft comprises measured data for one or more altitude parameters;
generate abnormal altitude variation prediction for at least one reference aircraft of the one or more reference aircrafts by analyzing the altitude dataset for the at least one reference aircraft;
generate a predicted clear air turbulence (CAT) output based on the abnormal altitude variation prediction for the at least one reference aircraft, wherein the predicted CAT output indicates a likelihood of CAT in the prospective segment of the flight path; and
initiate performance of one or more mitigation actions based on the predicted CAT output.
